(19) United States
(12) Patent Application Publication
(10) Pub. No.: US 2003/0069821 A1
(43) Pub. Date: Apr. 10, 2003

(54) Risk management system for recommending options hedging strategies

(76) Inventor: Michael S. Williams, San Francisco, CA (US)

Correspondence Address: PILLSBURY WINTHROP LLP, 1600 Tysons Boulevard, McLean, VA, 22102, US

(21) Appl. No.: 10/233,164

(22) Filed: Aug. 29, 2002

Related U.S. Application Data
(60) Provisional application No. 60/315,334, filed on Aug. 29, 2001.

(51) Int. Cl. G06F 17/60

(52) U.S. Cl. 705/36

(57) ABSTRACT

A risk management system for use in generating, for any long or short stock position or an entire portfolio, one or more options hedging strategies to protect unrealized profits and to insure the position against directional market risk. The risk management system recommends a preferred options hedging strategy out of many possible strategies based on minimizing losses while maintaining profits, but users of the system can review other possible strategies and make their own selection using predetermined reward, cost, and risk goals. In addition, user's can modify the predetermined goals in a real-time mode and assess alternate options hedging strategies. The risk management system also monitors existing investor profiles and alerts the user when a hedging action is recommended based on pre-established parameters customized for a particular stock position or an entire portfolio. The system accomplishes these features, and others, through an easily learned, fast and efficient user interface.

### CROSS-REFERENCE TO RELATED APPLICATIONS

The present application is based on, and claims priority from U.S. Provisional Application No. 60/315,334, filed Aug. 29, 2001.

### BACKGROUND OF THE INVENTION

I. Field of the Invention

The present invention relates generally to a risk management tool and more specifically it relates to a risk management system for use in generating, for any long or short stock position or an entire portfolio, one or more options hedging strategies to protect unrealized profits and to insure the position against directional market risk. The risk management system recommends a preferred options hedging strategy out of many possible strategies based on minimizing losses while maintaining profits, but users of the system can review other possible strategies and make their own selection using predetermined reward, cost, and risk goals. In addition, user's can modify the predetermined goals in a real-time mode and assess alternate options hedging strategies. The risk management system also monitors existing profiles and alerts the user when a hedging action is recommended based on pre-established parameters customized for a particular stock position or an entire portfolio.

II. Description of the Prior Art

It can be appreciated that risk management tools for options trading have been in use for years. Typically though, these options risk management tools are comprised of stand alone, complex, analytical tools that are supplemented with tip oriented newsletters.

The main problem with conventional options risk management tools is that they are far too complex for the average broker or individual trader to understand and use. Another problem with conventional options risk management tools is that the tip oriented newsletters do not consider any particular investor's existing equity positions. Another problem with conventional options risk management tools is that they are not designed to be integrated into a user's existing Information Technology (IT) infrastructure. Another problem with existing options risk management tools is that they are not designed to hedge the risk of an entire portfolio. Another problem with existing options tools is that the user must have an extremely high level of risk management expertise to effectively utilize them. Another problem is that existing risk management tools merely measure risk, but do not recommend alternatives to mitigate risk.

While the conventional options risk management tools may be suitable for the particular purpose or position that they address, they are not suitable for use by the average user to generate long or short stock positions or strategies to protect unrealized profits and to insure a position against directional market risk.

### SUMMARY OF THE INVENTION

In view of the foregoing disadvantages inherent in the conventional types of options risk management tools now available, the present invention provides a construction wherein options risk management can be utilized by the average retail broker and individual investor to generate, for any long or short stock position or an entire portfolio, one or more options hedging strategies to protect unrealized profits and to insure the position against directional market risk. The risk management system recommends a preferred hedging strategy out of many possible strategies based on minimizing losses while maintaining profits, but users of the system can review other possible strategies and make their own selection using predetermined reward, cost, and risk goals. In addition, user's can modify the predetermined goals in a real-time mode and assess alternate risk management strategies. The risk management system also monitors existing positions and alerts the user when a hedging action is recommended based on pre-established parameters customized for a particular stock position or an entire portfolio.

The present invention is generally designed to: 1) be extremely user friendly, 2) facilitate quick action by the user, 3) be readily and fully integrated into a user's existing IT infrastructure, trade execution systems, and book of business (i.e., the clients's portfolios), 4) hedge individual stock positions as well as entire portfolios, 5) utilize a 3-tier search which minimizes losses while maintaining profits, 6) search and identify the optimal risk management strategy from a potential population of more than 40 options hedging strategies, some of which are unique strategies of the present invention, 7) rollover or close out hedged positions, 8) provide proactive alerts to inform a user of recommended actions based on previously established market criteria specific to an individual investor, and 9) use embedded analytical tools to recommend the optimal options hedging strategy based on the same criteria mentioned in (8).

There has thus been outlined, rather broadly, the more important features of the present invention in order that the detailed description thereof may be better understood, and in order that the present contribution to the art may be better appreciated. There are additional features of the invention that will be described hereinafter.

A primary object of the present invention is to provide a risk management system that will overcome the shortcomings of the conventional options risk management tools.

An object of the present invention is to provide a risk management system for average users (i.e., retail brokers, independent financial advisors, hedge fund managers, individual investors, etc.) to generate, for any long or short stock position or an entire portfolio, one or more options hedging strategies to protect unrealized profits and to insure the position against directional market risk. The risk management system recommends a preferred hedging strategy out of many possible strategies based on minimizing losses while maintaining profits, but users of the system can review other possible strategies and make their own selection using pre-established reward, cost, and risk goals.

Another object is to provide a risk management system that maximizes the risk/return relationship of a particular equity investment by conducting a real-time technical evaluation yielding a customized recommendation for the optimum hedging strategy by proactively considering potential stock catalysts, a user's outlook, and an investor's outlook, all via a user friendly interface that is integrated into the user's existing IT infrastructure.

Another object is to provide a risk management system that proactively alerts a user to a market action in a particular stock of an investor, including the following: 1) the approaching expiration of an option position, 2) hitting a previously determined high or low price, 3) the timing of an approaching dividend or a dividend value change announcement, 4) the timing of an approaching earnings announcement, 5) a trading halt, 6) a sector alert indicating a sector or bellwether stock is trading outside of a predetermined range, 7) a rating change for that stock, and 8) the potential to lock in maximum profit or loss on the position.

Another object is to provide a risk management system that considers a user's outlook on an individual stock before recommending an option strategy to a client.

Another object is to provide a risk management system that customizes recommended options hedging strategies for an individual investor by considering the following: 1) the investor's existing position (type and amount of stock), 2) the investor's outlook (i.e., bullish, bearish, volatile, neutral, etc.) on the position, 3) any existing hedges on the position, 4) the investor's general risk tolerance (how much they are willing to lose), 5) the investor's time horizon, and 6) the investor's authorized trading level.

Another object is to provide a risk management system that is capable of being fully integrated into a user's existing IT infrastructure, including a one way link with the user's book of business, which captures an investor's stock and option positions, and an incoming link from the user's existing live data feeds. In addition, the risk management system is designed to minimize the user's IT security risk.

Another object is to provide a risk management system that emphasizes ease of use by utilizing a familiar “Windows-like” graphical user interface and functionality, which will accelerate a user's acceptance of, and productivity with, the system.

Another object is to provide a risk management system that employs a flexible design that facilitates fast action in managing an investor's portfolio by enabling a trade to be made quickly from the point of a system alert, considering all of the factors specific to the investor's outlook noted above as well as prioritizing the possible investor actions based on the user's designated logic.

Other objects and advantages of the present invention will become obvious to the reader and it is intended that these objects and advantages are within the scope of the present invention.

### BRIEF DESCRIPTION OF THE DRAWINGS

The above-mentioned and other features and advantages of the present invention will become more apparent from the detailed description set forth below when taken in conjunction with the drawings in which like reference characters identify correspondingly throughout and wherein:

FIG. 1 illustrates a block diagram of the architectural framework;

FIG. 2 illustrates the search functional flow;

FIG. 3 illustrates some of the numerous possible options hedging strategies;

FIGS. 4A-D illustrate a user display view of the alert bar, alert matrix, investor profile, and risk management strategy;

FIGS. 5A-D illustrate the alerts functional flow;

FIG. 6 illustrates computer security features for user's network; and

FIG. 7 illustrates computer integration features to user's network.

DETAILED DESCRIPTION OF A PRESENTLY PREFERRED EMBODIMENT

According to a presently preferred embodiment, the present invention is generally designed to: 1) be extremely user friendly, 2) facilitate quick action by the user, 3) be readily and fully integrated into a user's existing IT infrastructure, trade execution systems, and book of business (i.e., the clients' portfolios), 4) hedge individual stock positions as well as entire portfolios, 5) utilize a 3-tier search which minimizes losses while maintaining profits, 6) search and identify the optimal risk management strategy from a potential population of more than 40 strategies, some of which are unique strategies of the present invention, 7) rollover or close out hedged positions, 8) provide proactive alerts to inform a user of recommended actions based on previously established market criteria specific to an individual investor, and 9) use embedded analytical tools to recommend the optimal options hedging strategy based on the same criteria mentioned in (8).

The present invention will now be described in detail with reference to the accompanying drawings, which are provided as illustrative examples of preferred embodiments of the present invention.

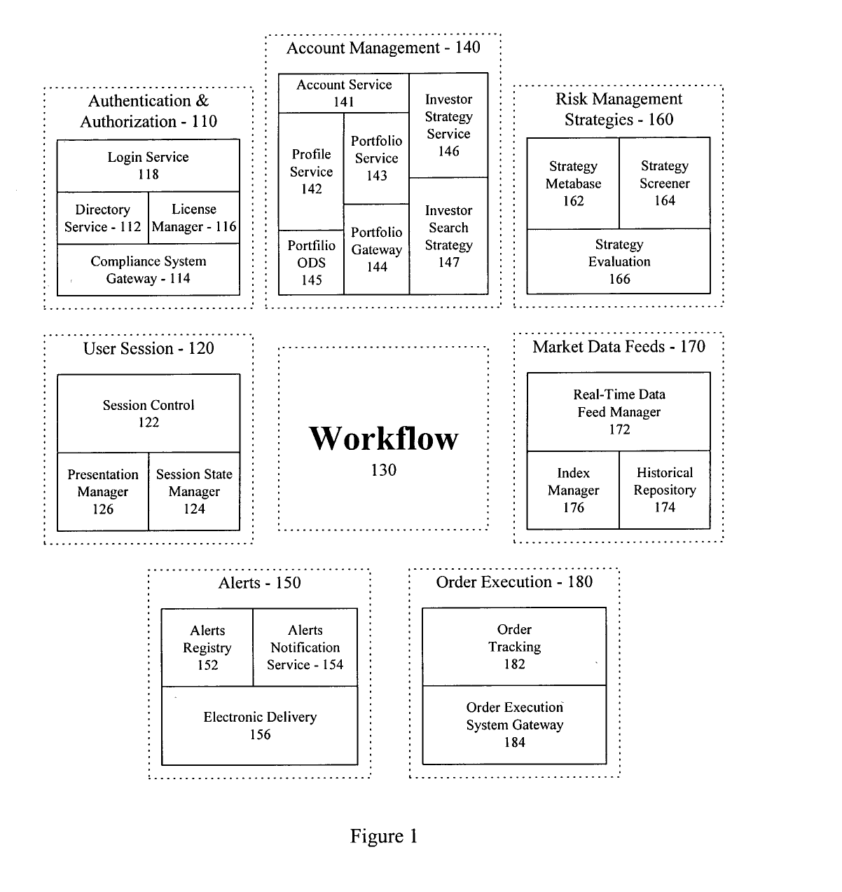

According to a presently preferred embodiment, the present invention is comprised of a series of“components” (see, FIG. 1). The authorization & authentication 110 component periodically pulls licensing information from external servers and updates local storage at the user's location. This action is configured and controlled by the user. This component might also, depending on user policy, replicate compliance information into the directory service 112 subcomponent. The user session 120 component validates requests against user security attributes and session state, and forwards requests to the workflow 130 component. The workflow 130 component monitors the completion of tasks until fulfillment of their business processes. The account management 140 component, depending on user policy, replicates portfolio information into the portfolio operational data storage 145 subcomponent. The alerts 150 component scans for external events (such as live market data, portfolio changes, etc.) that satisfy investors' profiles and generates alerts. The risk management strategies 160 component pulls new strategies from external servers. The market data feeds 170 component monitors feed events and notifies the rest of the system if and when a new event arrives (such as stock value change, trading halt, feed down, etc.). The order execution 180 component monitors orders, transactionally, to ensure their proper and complete execution.

The authorization & authentication 110 component periodically pulls licensing information from external servers and updates local storage with this information. This action is configured and controlled by the user. This component might also, depending on user policy, replicate compliance information into the directory service 112 subcomponent. The authentication & authorization 110 component could also be utilized to execute a variable pricing strategy which would link revenue with either the volume by time period, or user level activity versus prior period or sequential period, or some combination thereof.

The incoming data for the authentication & authorization 110 component include: 1) login credentials from the user session 120 component, 2) licensing authorization from external servers to enable users' access to the system, and 3) compliance information from the user's network to enable users' access to the system. The outgoing data from this component include: 1) security attributes to the user session 120 component. This component also uses two-way data exchange between itself and dedicated servers and the user's enterprise servers.

The authentication & authorization 110 component includes 4 subcomponents: 1) directory service, 2) compliance system gateway, 3) license manager, and 4) login service. The directory service 112 subcomponent identifies users' hierarchical organizational roles and organizational units and assigns/verifies security levels by individual and/or organization. This subcomponent provides for nonvolatile storage of security attributes including, among other items: credentials, permissions, customization by organizational unit, and optional personalization by individual user. The compliance system gateway 114 subcomponent provides access to a user network's compliance information, including users' and investors' approved trading levels and market data access permissions. In addition, this subcomponent could be used to prompt a user or investor to seek additional options training and/or accreditation. The license manager 116 subcomponent synchronizes licensing information between the licensor and a user by periodically pulling licensing information from the licensor's external servers and matching it to licensing information stored locally at the user. The login service 118 subcomponent is layered over the other three subcomponents. It provides location transparency, tailored to a user's network policy, of security attributes. Changes to login features to meet an individual user's requirements are implemented at this level.

The user session 120 component validates requests against users' security attributes and session state, and forwards requests to the workflow 130 component. The user session 120 component may also track productivity as a ratio of options executed relative to options analyzed as a means of assessing future potential enhancements to the system.

The incoming data for the user session 120 component include: 1) requests from users to initiate a session, 2) responses from the workflow 130 component when monitoring whether a session is still live, and 3) alert notifications from the alerts 150 component. The outgoing data from this component include: 1) responses to users from the presentation manager 126 subcomponent, and 2) signals for starting or modifying a workflow.

The user session 120 component includes 3 subcomponents: 1) session control, 2) session state manager, and 3) presentation manager. The session control 122 subcomponent receives requests from users, validates the requests versus established security attributes and session state, forwards requests to the workflow 130 component, and receives responses and passes them to the presentation manager 126 subcomponent. The session state manager 124 subcomponent maintains all conversational states pertaining to user sessions, catches alert notifications until they are pulled down by users, and tracks sessions to identify idle sessions for termination when they trigger preset limits. The presentation manager 126 subcomponent receives responses and formats them for presentation using style-sheets and sends them to users (i.e., brokers).

The workflow 130 component monitors the completion of tasks until the fulfillment of their business processes. It is the hub of the system. It models business processes, provides for nonvolatile storage of task definitions and necessary activity conditions. In addition, the workflow 130 component monitors events and evaluates conditions to activate tasks and complete such tasks until the fulfillment of their business processes, including: order execution, user response times, database transactions, etc.

The account management 140 component, depending on user network policy, replicates portfolio information into the portfolio operational data storage 145 subcomponent.

The incoming data for the account management 140 component include: 1) portfolio information from the user's network regarding an investor. The outgoing data from this component include: 1) portfolio information on an investor to the user's network, and 2) potential investors for a particular options hedging strategy to the risk management strategies 160 component. This component also uses two-way data exchange between itself and: 1) user and investor profiles via the authentication & authorization 110 component to ensure strategies considered are within a user's established risk tolerance, and 2) strategies executed for an investor via the workflow 130 and order execution 180 components to maintain up-to-date investor portfolio information.

The account management 140 component includes 7 subcomponents: 1) account service, 2) profile service, 3) portfolio service, 4) portfolio gateway, 5) portfolio operational data storage (ODS), 6) investor strategy service, and 7) investor search service. The account service 141 subcomponent provides an interface to manage user and investor profiles and investor portfolios. The profile service 142 subcomponent provides for nonvolatile storage of investor profiles regarding an individual stock, including the investor's sentiment (i.e., bullish, bearish, volatile, neutral, etc.), investment objective, risk tolerance, and time frame for hedging the position. The portfolio service 143 subcomponent provides access to investors' portfolios. Depending on user network policy, it either accesses investors' portfolios directly (i.e., on demand) from the user's network through the portfolio gateway 144 subcomponent, or accesses investors' portfolios from the portfolio ODS 145 subcomponent. The portfolio gateway 144 subcomponent provides access to specific user network portfolio management systems. The portfolio ODS 145 subcomponent provides for nonvolatile storage of investors' portfolios. It permits the options risk management system to interact with a database without endangering applications within the user's existing computer network infrastructure. Depending on user network policy, the portfolio ODS 145 subcomponent may be necessary for security reasons, or the portfolio ODS 145 subcomponent may be required to be absence due to privacy compliance policies. The investor strategy service 146 subcomponent provides for nonvolatile storage of executed investor strategies. The investor search service 147 generates a list of investors from a user's book of business that matches a certain investor profile, stock position and stocks without a risk strategy executed. Access to the investor's profile and portfolio enables rapid implementation of additional options risk management strategies.

The alerts 150 component scans for events (such as live data, portfolio changes, etc.) that satisfy investors' profiles and generates user alerts. The alerts 150 component can be expanded to include additional markets based on time driven factors that users and investors may want to consider in their investment decisions.

The incoming data for the alerts 150 component include: 1) registering/un-registering a user's interest in receiving alerts from the account management 140 component, and 2) market data necessary to evaluate whether alerts should be triggered from the market data feeds 170 component. The outgoing data from this component include: 1) alert notifications to the user session 120 component, and 2) emails and other custom notices to other electronic devices through the user session 120 component.

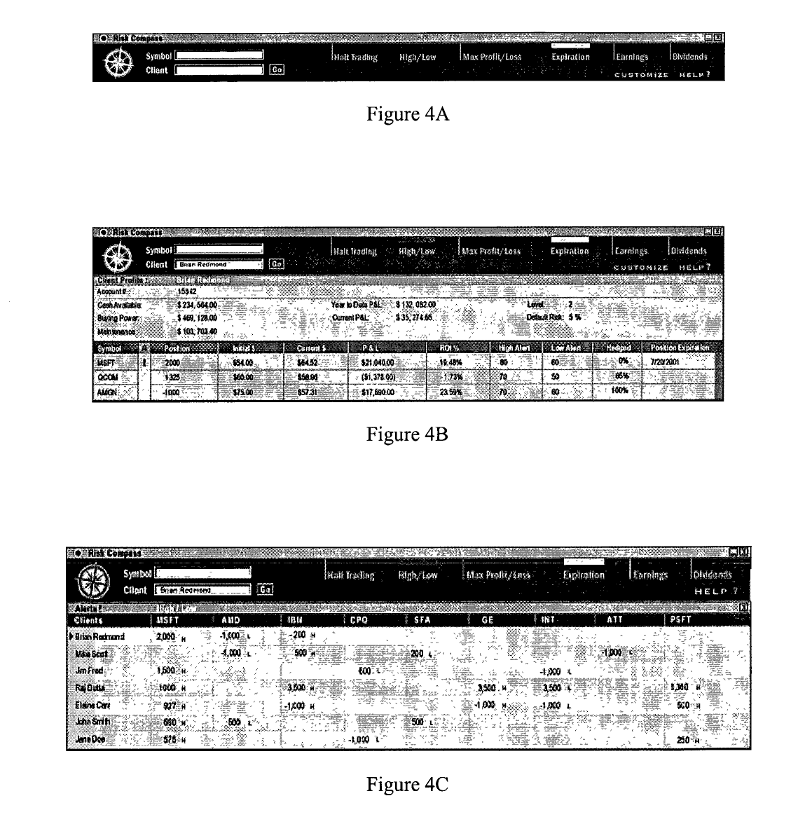

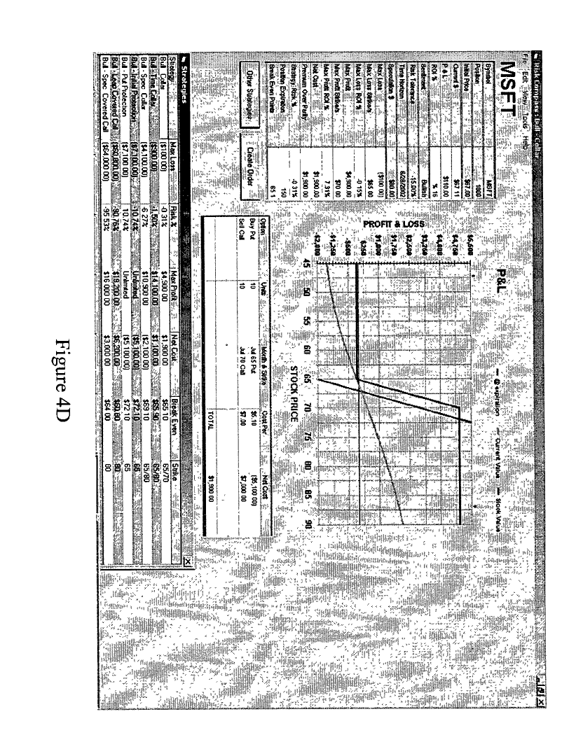

The alerts component includes 3 subcomponents: 1) alerts registry, 2) alerts notification service, and 3) electronic delivery. The alerts registry 152 subcomponent provides an interface to register and un-register users' interests in receiving alert notifications and notifies the alerts notification service 154 subcomponent of registration and un-registration events. In addition, the alerts registry 152 subcomponent consolidates interests of multiple users in the same alert to achieve optimal performance. It can also provide a list containing only the alerts for one particular user. The alerts notification service 154 subcomponent loads alerts registered by user when a user logs in and continues to update the list based on notification by the alert registry 152 subcomponent. In addition, it schedules continuous, periodic and on-demand alerts depending on the type of alert. It scans for events (such as live data, portfolio changes, etc.) that satisfy registered alerts. Finally, it publishes alerts by forwarding them for electronic delivery and organizes them in a user friendly alert matrix that lists individual investors on one axis and stocks on a second axis, with the matrix populated by stock positions for quick and easy action by the user (see FIGS. 4B-4C for an exemplary alert matrix). The electronic delivery 156 subcomponent can send alerts via email, pagers, faxes and other electronic formats.

The risk management strategies 162 component pulls new strategies from external servers.

The incoming data for the risk management strategies 160 component include: 1) register/un-register strategies from the authentication & authorization 110 component that defines the population of strategies for potential evaluation. The outgoing data from this component include: 1) list of applicable strategies to the account management 140 component for evaluation against an investor's and/or user's authorization level(s), and 2) strategy derived data to the account management 140 component for potential execution.

The risk management strategies component has 3 subcomponents: 1) strategy metabase, 2) strategy screener, and 3) strategy evaluator. The strategy metabase 162 subcomponent provides for nonvolatile storage of strategies metadata including, among other things, strategy name, type of position, sentiment (i.e., bullish, bearish, volatile, neutral, etc.), and strategy parameters and formulas. It provides an interface that allows retrieval of strategies based on users' and/or investors' permission (level of authorization) and licensing (from external servers) levels. The strategy screener 164 subcomponent intelligently screens strategies based on an investor's sentiment, existing stock positions and authorization level of both the user and investor. The strategy evaluator 166 subcomponent evaluates potential strategies and ranks them based on their risk/return relationship relative to the preset investor profile, including the investor's sentiment, time frame, risk tolerance and existing stock positions. It then provides a profit and loss graph illustrating the selected options risk management strategy including the investor's existing stock position. It also has an interface to access strategy details, including calculated fields, strike price, call and put options, etc. Additional investor criteria can be added to further refine the strategy evaluator 166 subcomponent (see, FIG. 4D).

The market data feeds 170 component monitors data feed events and notifies the rest of the system if and when a new event arrives (such as stock value change, trade stop, feed down, etc.).

The incoming data for the market data feeds 170 component include: 1) market data from external data-providers via the user session 120 component. The outgoing data from this component include: 1) market data events to users via the alerts 150 component, and 2) portfolio “best fit” index via the account management 140 component.

The market data feeds 140 component has 3 subcomponents: 1) real-time data feed handler, 2) historical repository, and 3) index manager. The real-time data feed handler 172 subcomponent provides an interface to access external data-provider feeds, supports both request/response and continuous broadcast systems, and simulates request/response for broadcast systems by caching data (keeping images and applying updates). The historical repository 174 subcomponent provides an interface to add and delete historical data and an interface to retrieve historical data. It can provide a database by which one could “back test” the risk management actions of a user as contrasted to taking no action to assess the profit or loss of such actions or inactions. The index manager 176 subcomponent provides for storage of the set of index symbols used for matching portfolios to indexes. It accesses either a data feed handler or a local repository to get components (i.e., stocks) of an index. It also incorporates symbol changes, buyouts, takeovers and mergers.

The order execution 180 component monitors orders, transactionally, to ensure execution.

The incoming data for the order execution 180 component include: 1) orders and executions from a user's network via the account management 140 component. The outgoing data from this component include: 1) user network orders to the account management 140 component, and 2) order execution progress to the workflow 130 component.

The order execution 180 component has 2 subcomponents: 1) order tracking and 2) order execution system gateway. The order tracking 182 subcomponent monitors orders to ensure execution occurs. It can also be used to monitor speed of execution versus expected speed. The order execution system gateway 184 subcomponent provides a gateway either to a user's order execution system, or to a third-party's order execution system.

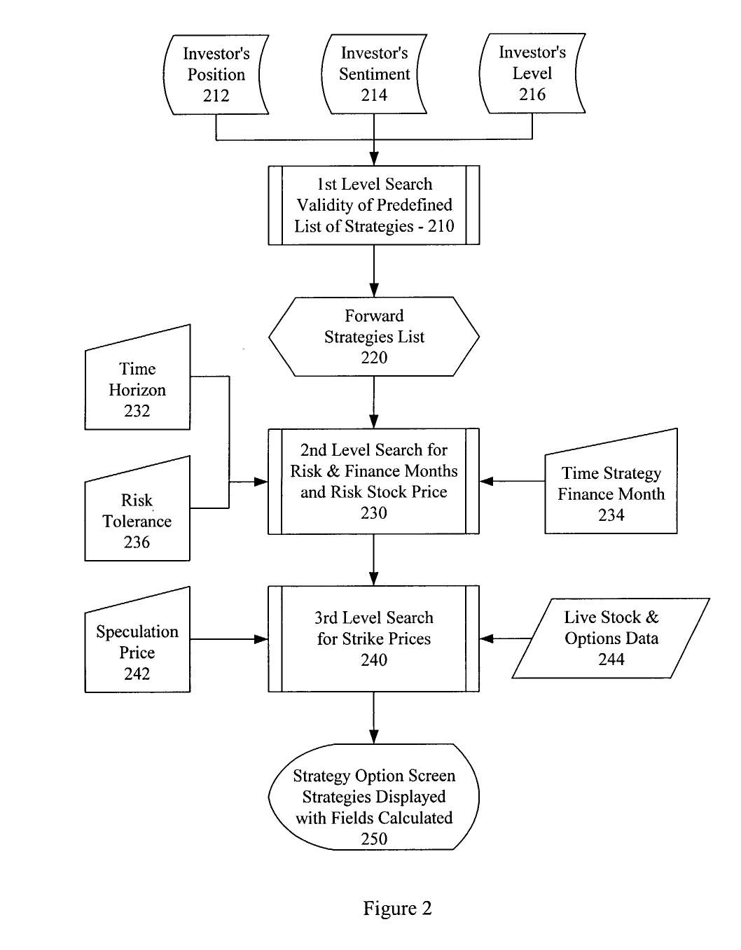

Another aspect of a presently preferred embodiment of the present invention includes the ability to search and identify the optimal risk management strategy from a potential population of more than 40 options hedging strategies, some of which are unique strategies of the present invention. FIG. 2 illustrates a flowchart of the search functionality. There are three levels to the search function of the present invention.

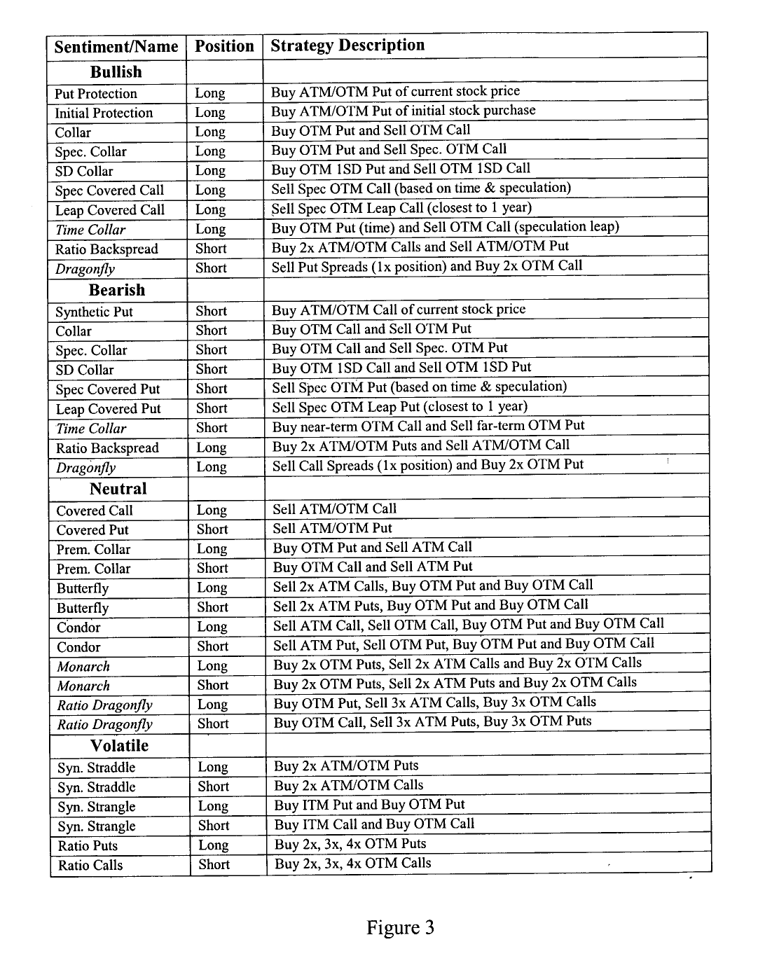

The first-level search 210 identifies and validates all possible options hedging strategies that match the investor's trading profile. The list of possible hedging strategies of a preferred embodiment of the present invention from which this search level can choose is illustrated in FIG. 3 (with proprietary strategies listed in italics). The first-level search 210 is divided into two sub-searches. The first sub-search identifies all the strategies that meet the investor's predetermined position 212, sentiment 214, and level 216. The first sub-search begins by selecting the set of strategies from the list of possible hedging strategies that matches the investor's position and sentiment. Then, this sub-search discards all the strategies from this set of strategies that require compliance levels higher than that of the investor. This results in a set of potential strategies that matches the investor's position, sentiment and level. The investor's position 212 is either long or short. The investor's sentiment 214 can be automatically determined from the position 212. For automatic determination, if the position 212 is long, then a bullish sentiment 214 is assumed; if the position 212 is short, then a bearish sentiment 214 is assumed. However, the user can override the automatically determined sentiment 214 and change it to a user determined sentiment (i.e., bullish, bearish, neutral, volatile, etc.). The investor's level 216 (i.e., level of investment expertise) is determined by the user and allows the user to decide which strategies are suitable for the investor based on the investor's capital and experience. The possible investor Levels 216 are: level 1 allows long calls and long puts, level 2 allows covered calls, level 3 allows spreads, and level 4 allows sell un-hedged (“naked”) options. The preferred embodiment facilitates user customization of these level definitions.

The second sub-search of the first-level search 210 checks whether data fields of the set of potential strategies identified in the first sub-search are valid. Some strategies might produce invalid fields for the investor's sentiment and compliance level. This sub-search also verifies the set of potential strategies against the user's compliance level. Strategies not meeting these criteria are considered invalid and removed from the set of potential strategies. All identified and valid strategies of the first-level search 210 are forwarded 220, as a strategies list, to the remaining search levels for parameter determination and ranking.

The second-level search 230 is also divided into two smaller sub-searches. The first sub-search determines the risk month and the finance month. The risk month is determined by assessing the investor's time horizon 232. The user can input the investor's time horizon 232 in one of three ways: as an absolute month, as an absolute date, or as a relative number of days. The first sub-search calculates the risk month as the first month with an options expiration date that is greater than or equal to the investor's pre-determined time horizon 232. The finance month, which is hedging strategy dependent, is the month used to sell options to finance the insurance month. If an identified strategy from the strategies list is a same-month strategy, then the finance month is the same month as the risk month. However, if an identified strategy on the strategies list is a time strategy (i.e., Time Collars, and other strategies using multiple months), then the finance month will be further out in time than the risk month. In this case, the time strategy finance month 234 is set by the user in one of the following two ways: the time strategy finance month is set to some number of months greater than the risk month (i.e., 1 month, 3 month, 6 months 9 months, 12 months), or the time strategy finance month is set to the 1st LEAP month or 2nd LEAP month.

The second sub-search of the second-level search 230 determines the risk stock price. The risk stock price is the stock value at which the investor is willing to take a maximum loss. The risk stock price is used to find the best option to use as the contract neutral hedge against the investor's long or short position. The formula for calculating the risk stock price is dependent upon the investor's risk tolerance 236 and whether the investor's position 212 is long or short. The user is able to enter in an actual stock price, a percentage, or a dollar amount for the investor's risk tolerance 236. As an example of how the risk stock price is calculated, assume the user has entered a percentage as the investor's risk tolerance 236. If the investor's stock position is long, then the risk stock price (long) is calculated as the current stock price minus the product of the risk tolerance percentage and the current stock price. For an investor's short stock position, the risk stock price (short) is calculated as the current stock price plus the product of the risk tolerance percentage and the current stock price. These two risk stock price calculations, long and short, are easily adapted to use the other two types of possible risk tolerance 236 entry as inputs, and are included within the boundaries of the present invention.

After the risk month, finance month and the risk stock price are calculated for each strategy on the strategy list, the strategy list is passed to the next search. The third-level search 240 is broken down into three sub-searches, or strike searches. The first strike search determines put strikes for the investor's long stock positions. This strike search finds the best put strike price to hedge the investor's long stock positions using the following formula: put strike price should be greater than or equal to the sum of the risk stock price (long) plus the put ask price, where the put ask price is provided via the live stock & options data 244 feed.

The second strike search of the third-level search 240 determines call strikes for the investor's short stock positions. This search finds the best call strike price to hedge the investor's short positions using the following formula: call strike price should be less than or equal to the difference between the risk stock price (short) minus the call ask price, where the call ask price is provided via the live stock & options data 244 feed.

The third strike search of the third-level search determines the finance strikes in the finance month. There are two types of finance strikes that are sold: a call finance strike and a put finance strike. This strike search will automatically find the finance strike if no speculation price 242 is entered for the particular stock. The speculation price 242 can be manually entered by the user. If a speculation price 242 is entered, then it is used to determine which finance strike is selected. The user can also change the two variables used in defining the finance strike. These two variables are the strike variable and the premium variable. The strike variable adjusts a finance strike price by adding to, or subtracting from, the current stock price. The premium variable allows a minimum value to be set for the extrinsic value of the finance strike being sold. For the call finance strike, the call strike price should be greater than the sum of the current stock price plus the strike variable, and the call extrinsic value should be greater than the premium variable. For the put finance strike, the put strike price should be less than the difference between the current stock price minus the strike variable, and the put extrinsic value should be greater than the premium variable.

Several of the options hedging strategies incorporate use of a standard deviation. In the context of the present invention, one standard deviation is calculated by taking the average implied volatility for a given timeframe (i.e., expiration month) measured from the last sale price of the underlying security (including applicable trading interest rates). To calculate the standard deviation for a given time period, the implied volatility is divided by the square root of the number of occurrences of the specified timeframe (i.e., trading days till expiration). In the case of a time strategy (i.e., the Time Collar) the standard deviation formula uses the near-term options expiration when determining the number of occurrences of the particular timeframe. The timeframe implied volatility is multiplied by the underlying security price (including applicable interest rates) defining the price range of one standard deviation.

To calculate the average implied volatility for a given expiration month, the two strikes closest to the current stock price are selected. The call and put mean implied volatilities for each strike are averaged, resulting in an average implied volatility per strike. These two average implied volatilities per strike are then averaged to calculate the expiration month average implied volatility. The implied volatility is a percentage of the underlying security (including applicable interest rates) as a function of one standard deviation. Implied volatilities are measured in one-year periods and have to be calculated at specified timeframes to ascertain the standard deviation over that specified timeframe.

After all three levels of the search function are complete, the strategy with the best, or least negative, max loss is automatically displayed to the user via the investor's strategy profile. The remaining strategies on the strategy list are displayed in tabular form in order of decreasing max loss. The max loss, along with the max profit and breakeven points, are calculated using system-defined strategy formulas. These formulas are defined using the following variables: a given stock price S, the strike price X, the intrinsic value, and the net value. The intrinsic value of an option is defined as the greater of S−X or 0 for calls, and the greater of X−S or 0 for puts. Using this definition of intrinsic value, the net value of a position containing any number of options at expiration stock price S is defined as:

the sum of the intrinsic values at stock price S for options that are sold;

minus, the sum of the intrinsic values at stock price S for options that are bought;

plus, the value of the stock position at stock price S (i.e., the product of stock price S and the stock position volume); and

minus, any commissions generated by these transactions.

Assuming there are m strikes in a stock position, then the max loss of the position is the minimum net value of the position when evaluated at each of the following stock prices:

stock price S₀=0;

stock prices S₁ through Sₘ (i.e., each strike contained in the position); and

stock price Sₘ=10¹².

If the max loss occurs at stock price Smₘ₊₁=10¹², then the position is considered to have an unlimited max loss.

Again, assuming m strikes in a stock position, then the max profit of the position is the maximum net value of the position when evaluated at each of the following stock prices:

stock price S₀=0;

stock prices S₁ through Sₘ (i.e., each strike contained in the position); and

stock price Sₘ+1=10¹².

If the max profit occurs at stock price Sₘ+=10¹², then the position is considered to have an unlimited max profit.

To calculate the breakeven points, first determine the net value sequence of the stock position using the following sequence of stock prices:

stock price S₀=0; then

stock prices S₁ through Sₘ (i.e., each strike contained in the position) in ascending order; then

stock price Sₘ+1=10¹².

If the sign of a net value in the net value sequence of the stock position at any stock price Sᵢ through Sₘ₊₁ differs from the sign of the net value in the net value sequence of the stock position at the previous stock price S₀ through Sₘ, respectively, then a breakeven point is generated. The breakeven point at some point i, where i is a variable between 1 and m+1, is calculated as follows:

Breakeven point=Sᵢ₋₁−NetValueᵢ₋₁*(Sᵢ−Sᵢ₋₁)/(NetValueᵢ₋₁NetValueᵢ₋₁),

where

NetValueᵢ is the net value of the position at stock price Sᵢ, and

NetValueᵢ₋₁ is the net value of the position at the previous stock price Sᵢ₋₁.

The breakeven points comprise the total set of points generated, as each stock price S₁ through Sₘ₊₁ is considered.

A further aspect of a presently preferred embodiment of the present invention is the alerts function. The alerts function employs a flexible design which facilitates fast action in managing an investor's portfolio by enabling a trade to be made quickly, from the point of the alerts, considering all of the factors specific to the investor's outlook as well as prioritizing the investor actions based on a user's designated logic. The alerts function alerts the user via a graphical display table, the alerts matrix, illustrated as FIGS. 4B and 4C. The alert matrix highlights all of the investors' positions that fall under a particular alert to allow the user to efficiently interact with the investors, to recommend actions, and to quickly and easily follow-through on an investor's acknowledged actions (i.e., buys, sells, executions, rollovers, etc.). FIG. 4A shows the alert bar, where the user commences the alerts function process.

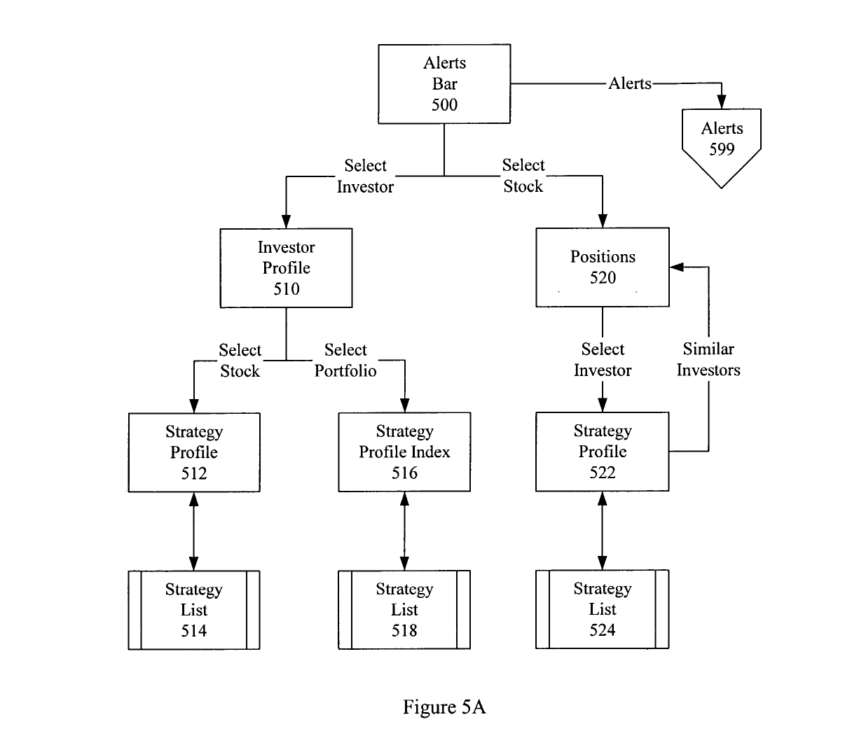

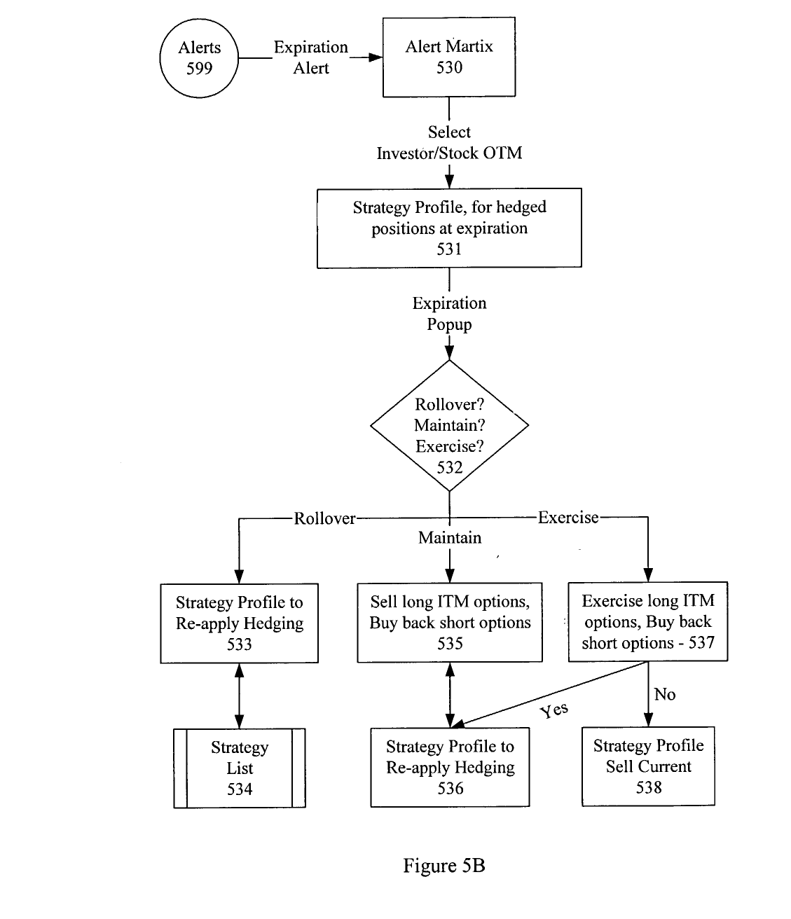

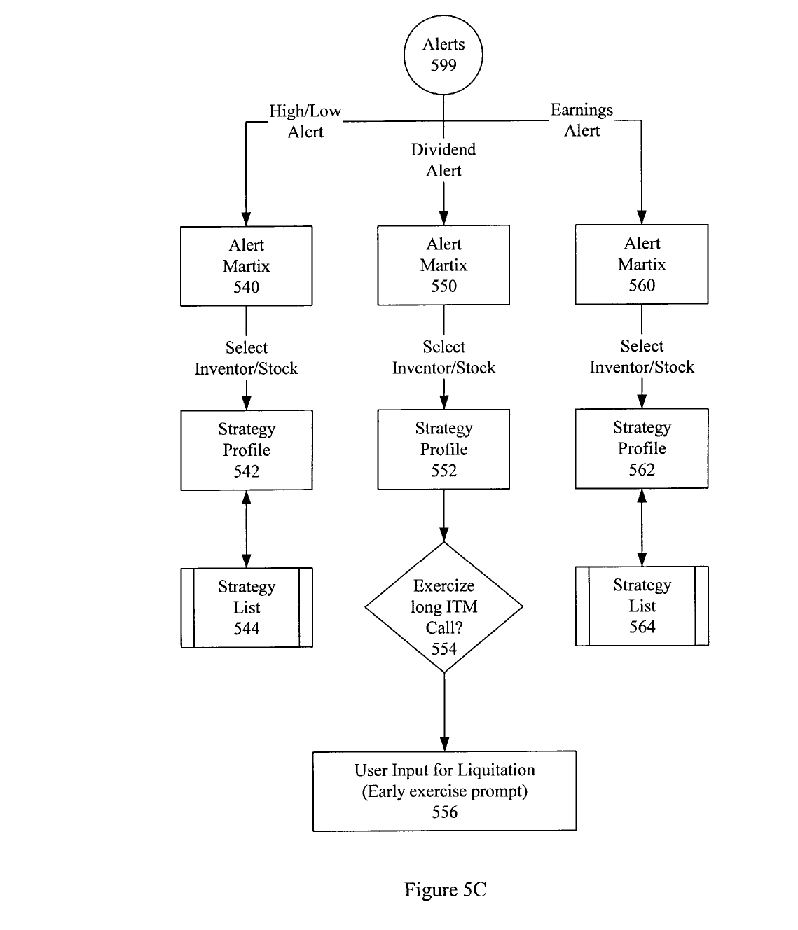

The alerts function is designed to proactively alert a user to a market action in a particular stock of an investor, including, but not limited to, the following market actions: 1) an expiration alert announcing an impending expiration of an option position, 2) a high/low alert upon hitting a pre-determined high or low price point, 3) a dividend alert announcing an approaching dividend or dividend value change, 4) an earnings alert indicating an approaching earnings announcement, 5) an ST alert when there is a trading stop or halt, 6) a sector alert indicating when a sector or bellwether stock is trading outside of a predetermined range, 7) a rating alert whenever an analyst changes the rating for a particular stock, and 8) a max profit/loss alert showing the potential to lock in the maximum profit or loss on the position. FIGS. 5A-D illustrate the alerts functional flow and processing.

Referring again to FIGS. 4A-4D, the user can commence an alerts function assessment from the alerts bar of FIG. 4A in one of three ways: by selecting an investor (i.e., a client) as in FIG. 4B, by selecting a stock (i.e., a Symbol) or by selecting an individual alert indicator as in FIG. 4C. Regardless of which way the user initiates an alerts function assessment, the user will ultimately down-select to a single investor's risk management strategy position and profile as shown in FIG. 4D.

As illustrated in FIG. 5A, if the user first selects an investor in the alerts bar 500, the system responds by displaying the investor profile 510, from which the user can now select either a single stock of that investor or that investor's portfolio. If a single stock for that investor is selected, then the investor's strategy profile 512 for that stock is displayed along with the investor's strategy list 514 for that stock. If the portfolio for that investor is selected, then the investor's strategy profile index 516 for the portfolio is displayed along with the investor's strategy list 518 for the portfolio. The user can interact with the investor's strategy list 514, 518 to assess the current strategy, investigate new strategies, or perform “what-if” type analyses.

If, however, the user first selects a stock in the alerts bar 500, the system responds by displaying the positions 520 of that stock, from which the user can now select an investor with that position. Once an investor with that position is selected, the investor's strategy profile 522 for that position is displayed along with the investor's strategy list 524 for that position. The user can interact with the investor's strategy list 524 to assess the current strategy, investigate new strategies or perform “what-if” type analyses. Also part of the alerts bar 500 are alert indicators for the system proactive alerts. When an alert is generated, the corresponding alert indicator on the alerts bar 500 is made active and distinguishable from the alert indicators with no associated proactive alerts. Upon noticing the active alert indicator on the alerts bar 500, the user simply selects that alert indicator to bring up investors and positions affected by that generated alert.

Specifically, referring to FIG. 5B, after an expiration alert is generated and the user selects the corresponding alert indicator on the alerts bar 500, the alert matrix 530 is populated with investors and positions affected by the expiration alert. The user then selects a specific investor from the alert matrix. The system responds with the investor's strategy profile 531 for hedged positions at expiration. Also, the system brings up an expiration popup 532 menu from which the user can choose whether to rollover, maintain, or exercise the expiring hedged position. If the user chooses rollover, the system displays the investor's strategy profile 533 for that position so that the user can re-apply the hedging strategy. The user might also choose a different hedging strategy from the investor's strategy list 534 for that position. If the user chooses maintain, the system selects to close out the existing hedging strategy and to maintain the underlying security (i.e., sell long ITM options and buy back short options 535, if any). Following these actions, the system displays the investor's strategy profile 536 for that position so that the user can re-apply a hedging strategy. Finally, if the user chooses exercise, the system selects to exercise long ITM options (based on extrinsic value) and buys back short options 537, if any. If no options are exercised or bought, then the system selects to sell the current position 538. If options are exercised or bought, then the system displays the investor's strategy profile 536 for that position so that the user can re-apply a hedging strategy.

As FIG. 5C illustrates, for a high/low alert or earnings alert, the system follows the same flow sequence. First, the alert matrix 540, 560 is filled in with the affected investors and positions for the alert. The user then selects an investor and position of interest and the system responds with that investor's strategy profile 542, 562 for that stock along with the investor's strategy list 544, 564 for that stock. The user can interact with the investor's strategy list 544, 564 to see how the particular alert affects hedging, assess the current strategy, investigate new strategies or perform “what-if” type analyses. For a dividend alert, the flow is similar to the high/low and earnings alert. However, after the alert matrix 550 is filled and the strategy profile 552 for the selected investor and position is displayed, the system prompts the user of the possibility of exercising long ITM calls 554, 556 that meet the extrinsic value criteria before the dividend action occurs.

FIG. 5D shows that once an ST alert, a rating alert, or a sector alert has been generated, indicated, and selected via the alert bar 500, the only step made by the system is to populate the alert matrix 570, 572, 574 with the affected investors and positions of the particular alert. Although, in response to a generated, indicated, and selected max profit/loss alert, the system performs several steps. First, the system populates the alert matrix 580 with the investors and positions affected by the max profit/loss alert. The user then selects a particular investor and position to investigate further. The system loads the current position, with associated hedging strategy, in the investor's strategy profile, from which the user can choose whether to rollover, maintain, or exercise the affected position. If the user chooses rollover, the system displays the investor's strategy profile 582 for that position so that the user can re-apply the hedging strategy. The user might also choose a different hedging strategy from the investor's strategy list 583 for that position. If the user chooses maintain, the system selects to close out the existing hedging strategy and to maintain the underlying security (i.e., sell long ITM options and buy back short options 584, if any). Finally, if the user chooses exercise, the system selects to exercise the long ITM options and buys back short options 586, if any. If no options are exercised or bought, then the system selects to sell the current position 587. If options are exercised or bought, then the system displays the investor's strategy profile 585 for that position so that the user can re-apply a hedging strategy.

The primary users of a presently preferred embodiment of the options risk management system might include: retail brokers, individual investors, external servers, options research departments, developers, and systems administrators. Retail brokers might interact with the system on behalf of their clients. The clients, therefore, would not directly interact with the options risk management system. The retail brokers would use the system to analyze client's portfolios, make suggestions, and execute options hedging strategies on behalf of the client. Individual investors might interact with the system in the same manner as retail brokers. External servers could interact with the options risk management system in a number of ways: (a) identify and maintain a set of predefined options hedging strategies and related parameter values; (b) define contractual agreements between system supplier and users, and (c) extract and analyze log information for system improvements and enhancements. Options research departments of large brokerage firms will be allowed to modify and add strategies and parameter values. These modifications or additions will be captured by the options risk management system. Developers can use the public application program interfaces (APIs) provided with the options risk management system to integrate the system with the developer's existing IT infrastructure. Systems administrators might be responsible for installation and upgrade of options risk management system and should provide first level support to users. They will also be involved in linking external networks with any core systems within their IT systems (i.e., live data feed, account management data, compliance and order execution systems).

The options risk management system takes inputs from users (i.e., retail brokers, individual investors, external servers, options research departments, systems administrators, etc.) and also from computerized systems (i.e., directory service, compliance, license manager, workflow, profiles, portfolios, alerts registry, strategies metabase, real time feed handlers, index manager, etc.). Retail Brokers might send requests to the system through a web browser. The types of requests might include: logging into the system, navigating between system screens, selecting client lists, exploring risk management strategies, and choosing alerts upon which to act. Additionally, retail brokers might enter and modify client lists, client accounts, client positions, client position strategy lists, client portfolios, client strategy profiles, explore risk strategy positions, explore risk strategy lists, and explore risk strategy profiles and applicable client list pages. Individual investors might provide the same inputs to the system as do the retail brokers. External servers could interact with the options risk management system in two ways: 1) by entering and modifying a set of predefined options hedging strategies and related parameter values, and 2) entering/modifying contractual agreements between system supplier and users. Options research departments of large brokerage firms will be allowed to modify/add strategies and parameter values. Systems administrators should enter system configuration parameters. The directory service provides the options risk management system with a user's hierarchical organizational role and organizational unit as well as security attributes. The user's compliance information is provided to the options risk management system either directly from user's existing compliance system or indirectly from mirror compliance information stored locally within the options risk management system. The license manager subcomponent provides licensing information to the options risk management system. Licensing information is periodically refreshed within the license manager via external servers. The options risk management system takes business process definition inputs from the workflow component. The system gets investor profile sentiment value, investment objective, risk tolerance and timeframes per stock position from the user's and the investor's Profiles. The system obtains investors' portfolios either directly from user's existing portfolio system or indirectly from mirror portfolio information stored locally within the options risk management system. The options risk management system provides an interface to register and un-register a user's interests in receiving alerts notifications, to retrieve strategies based on a user's and/or an investor's permissions and licensing levels, to access data provider feeds, to retrieve historical data, and to access index symbols used for matching portfolios.

The options risk management system provides three types of outputs: 1) it responds to user's requests for action/information, 2) it sends order execution requests through a gateway to an order execution system, and 3) it logs information to form an audit trail.

A typical risk management strategy scenario of the present invention is for a broker to log into the system and explore various options risk management strategies. The broker interacts with the risk management strategy page by entering a stock symbol, position, risk (default will be used if no value is entered), speculation price, sentiment (default will be used if no value is entered), and time frame to insure the position. The system will update the current stock value. The broker chooses to evaluate strategies and the system will display all matched and valid options hedging strategies in a rank-order listing. The broker studies the details of one or more strategies and then picks one of them. After deciding which options hedging strategy to pursue, the broker scans all clients with similar un-hedged positions and sentiments. Finally, the broker chooses a client from the list, displays the client position strategy profile, and informs him/her how to protect his/her profits (see, FIG. 4D).

A typical max profit scenario of the present invention is for a broker to log into the system and monitor the alerts matrix. When the alert matrix indicates, for example, that new max profit alerts have been generated, the broker selects, or clicks-on, the max profit alert indicator. As a consequence of this selection, the system displays the list of all max profit alerts for all clients. The broker simply picks one of the max profit alerts (i.e., client and stock) and executes one of the exit strategies after receiving the client's permission (see, FIGS. 4B-4C).

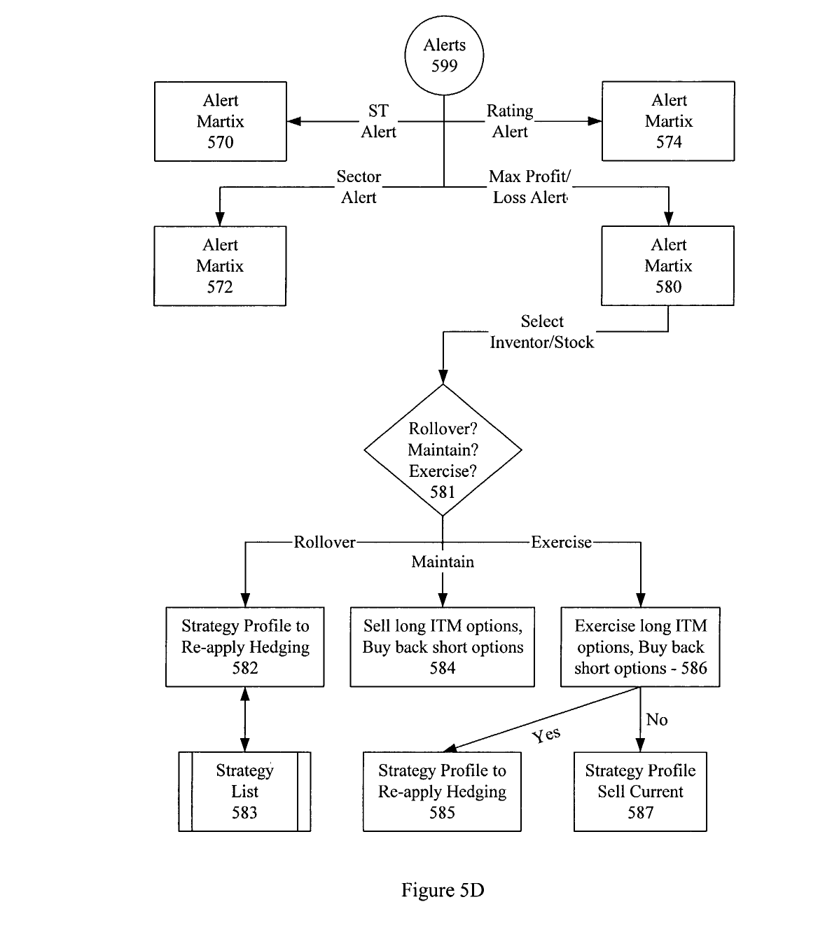

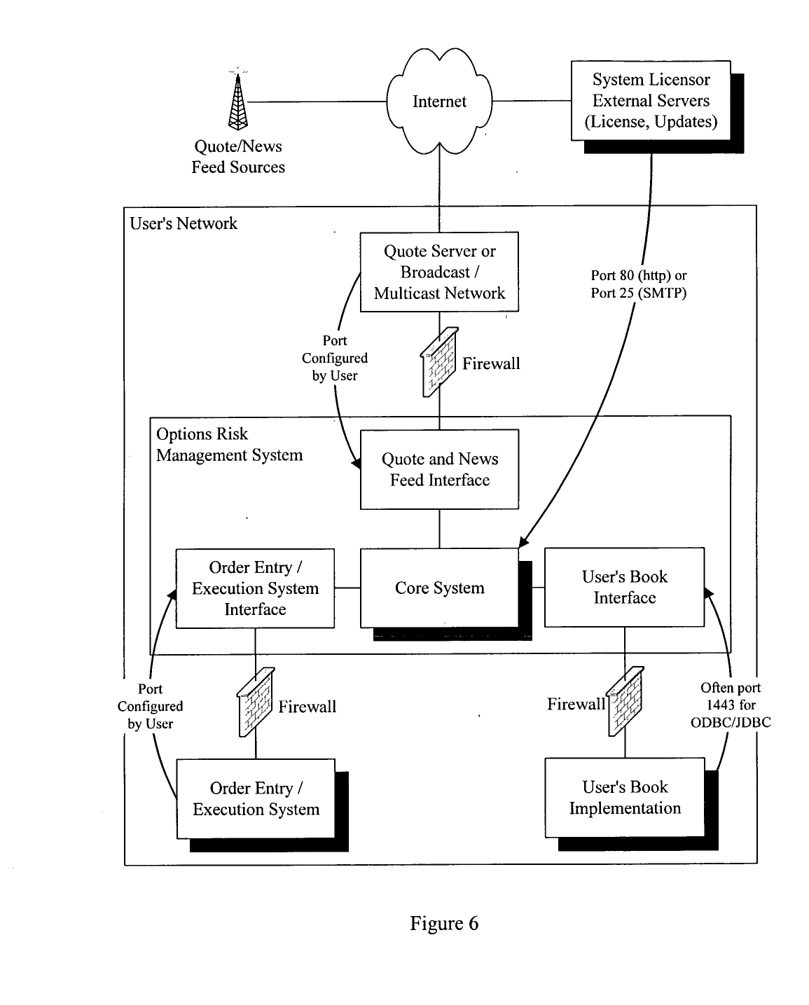

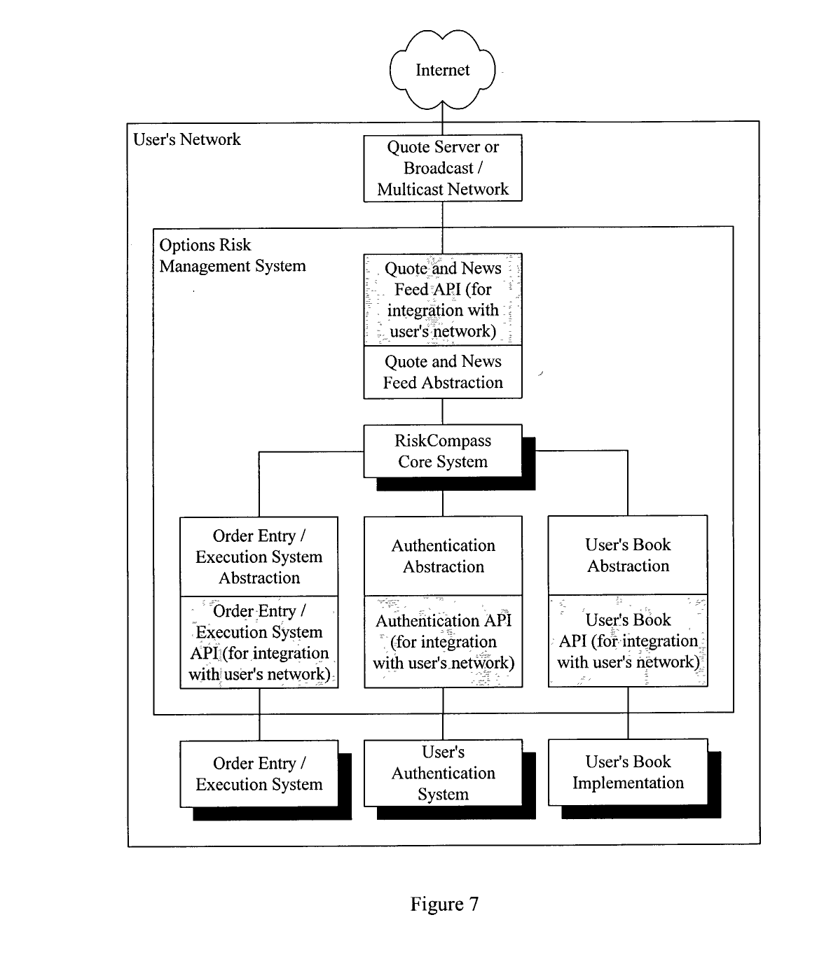

Aspects of a presently preferred embodiment of the present invention include an options risk management system that provides security to the user's computer network and easily integrates with the user's computer network. See FIG. 6 and FIG. 7 for an illustrative example of the options risk management system's security and integration features, respectively. As shown in FIG. 6, the access ports between the options risk management core system and the user's network can be protected by firewalls and configurable by the user. These features provide a high degree of security to the user, without limiting core system functionality. Additionally, as shown in FIG. 7, the options risk management core system provides interface abstraction application program interfaces (APIs) for ease of integration with the user's computer network. APIs are a set of routines, protocols, and tools for building software applications. A good API makes it easier to develop a program by providing the necessary building blocks for the programmer to use when developing system interfaces. Although APIs are designed for programmers, they are ultimately good for users because they guarantee that all programs using a common API will have similar interfaces. This makes it easier for users to learn and become efficient at new programs.

While the present invention has been described herein with reference to particular embodiments thereof, a latitude of modification, various changes and substitutions are intended in the foregoing disclosure. Accordingly, it will be appreciated that in some instances some features or aspects of the invention will be employed without a corresponding use of other features or aspect, without departing from the spirit and scope of the invention as set forth in the appended claims.

What is claimed is:

1. A computer-based risk management method for options hedging, the method comprising:
loading a plurality of hedging strategies;
entering a set of inputs;
executing a selection algorithm, wherein the selection algorithm selects a set of hedging strategies from the plurality of hedging strategies using the set of inputs;
calculating at least one ranking criterion for each hedging strategy in the set of hedging strategies; and
displaying a ranked set of hedging strategies, wherein the ranked set of hedging strategies is sorted on the at least one ranking criterion.

2. The computer-based risk management method of claim 1, wherein the plurality of hedging strategies includes at least one of a time collar long strategy, and a time collar short strategy.

3. The computer-based risk management method of claim 1, wherein the plurality of hedging strategies includes at least one of a dragonfly long strategy, and a dragonfly short strategy.

4. The computer-based risk management method of claim 1, wherein the plurality of hedging strategies includes at least one of a monarch long strategy, and a monarch short strategy.

5. The computer-based risk management method of claim 1, wherein the plurality of hedging strategies includes at least one of a ratio dragonfly long strategy, and a ratio dragonfly short strategy.

6. The computer-based risk management method of claim 1, wherein the set of inputs comprises:
an investor profile, the investor profile including a position, a sentiment, and an investor level;
an investor portfolio, the investor portfolio including a holding, a time horizon, a risk tolerance, and a speculation price;
a user profile, the user profile including a user level, a time strategy finance month, a strike variable, and a premium variable; and
external investment data, the external investment data including current stock prices, current option prices, and options expiration dates.

7. The computer-based risk management method of claim 6, wherein the selection algorithm includes:
a first-level search, wherein the first-level search selects the set of hedging strategies from the plurality of hedging strategies using the position, the sentiment, the investor level, and the user level;
a second-level search, wherein the second-level search calculates a risk month, a finance month and a risk stock price for each hedging strategy in the set of hedging strategies using the time horizon, the options expiration dates, the time strategy expiration month, the risk tolerance, the position, and the current stock prices; and
a third-level search, wherein the third-level search determines at least one strike price and a finance strike for each hedging strategy in the set of hedging strategies using the position, the risk stock price, the current options prices, the speculation price, the current stock prices, the strike variable and the premium variable.

8. The computer-based risk management method of claim 7, wherein the at least one ranking criterion is a max loss, the max loss calculated for each hedging strategy in the set of hedging strategies using the position, the current stock prices, the at least one strike price, and the current options prices.

9. The computer-based risk management method of claim 8, further comprising calculating a max profit, the max profit calculated for each hedging strategy in the set of hedging strategies using the position, the current stock prices, the at least one strike price, and the current options prices.

10. The computer-based risk management method of claim 8, further comprising calculating at least one breakeven point, the at least one breakeven point calculated for each hedging strategy in the set of hedging strategies using the position, the current stock prices, the at least one strike price, and the current options prices.

11. The computer-based risk management method of claim 1, further comprising executing an options hedging strategy alert system.

12. The computer-based risk management method of claim 11, wherein the options hedging strategy alert system comprises:
accepting identification of at least one investor, the at least one investor having a profile, at least one portfolio holding, and at least one selected options hedging strategy for the at least one portfolio holding;
generating at least one alert from a set of alerts, the at least one alert generated using the profile, the at least portfolio holding, and the at least one selected options hedging strategy; and
performing at least one automatic response using the at least one alert.

13. The computer-based risk management method of claim 12, wherein the set of alerts comprises at least one of:
an expiration alert, the expiration alert announcing an impending expiration of the at least one selected options hedging strategy for the at least one portfolio holding;
a high-low alert, the high-low alert indicating the at least one portfolio holding reached a price set point of the profile;
a dividend alert, the dividend alert indicating at least one of an approaching dividend payout and a dividend value change for the at least one portfolio holding;
an earnings alert, the earnings alert indicating an approaching earnings announcement for the at least one portfolio holding;
an ST alert, the ST alert announcing a trading halt for the at least one portfolio holding;
a sector alert, the sector alert indicating a sector stock trading outside of a sector stock price range of the profile;
a rating alert, the rating alert indicating a rating change for the at least one portfolio holding; and
a max profit-loss alert, the max profit-loss alert showing at least one of a maximum profit and a maximum loss of the at least one selected options hedging strategy for the at least one portfolio holding.

14. The computer-based risk management method of claim 12, wherein the at least one automatic response includes a rollover response of the at least one selected options hedging strategy for the at least one portfolio holding.

15. The computer-based risk management method of claim 12, wherein the at least one automatic response includes a maintain response of the at least one selected options hedging strategy for the at least one portfolio holding.

16. The computer-based risk management method of claim 12, wherein the at least one automatic response includes an exercise response of the at least one selected options hedging strategy for the at least one portfolio holding.

17. The computer-based risk management method of claim 1, further comprising a means for integration into a user network.

18. The computer-based risk management method of claim 1, further comprising a means for providing network security to a user network.

19. A computer-readable medium having instructions for a risk management system stored thereon which when executed by a processor performs the steps of:
loading a plurality of hedging strategies;
accepting entry of a set of inputs;
executing a selection algorithm, wherein the selection algorithm selects a set of hedging strategies from the plurality of hedging strategies using the set of inputs;
calculating at least one ranking criterion for each hedging strategy in the set of hedging strategies; and
displaying a ranked set of hedging strategies, wherein the ranked set of hedging strategies is sorted on the at least one ranking criterion.

20. The computer-readable medium of claim 19, wherein the plurality of hedging strategies includes at least one of a time collar long strategy, and a time collar short strategy.

21. The computer-readable medium of claim 19, wherein the plurality of hedging strategies includes at least one of a dragonfly long strategy, and a dragonfly short strategy.

22. The computer-readable medium of claim 19, wherein the plurality of hedging strategies includes at least one of a monarch long strategy, and a monarch short strategy.

23. The computer-readable medium of claim 19, wherein the plurality of hedging strategies includes at least one of a ratio dragonfly long strategy, and a ratio dragonfly short strategy.

24. The computer-readable medium of claim 19, wherein the set of inputs comprises:
an investor profile, the investor profile including a position, a sentiment, and an investor level;
an investor portfolio, the investor portfolio including a holding, a time horizon, a risk tolerance, and a speculation price;
a user profile, the user profile including a user level, a time strategy finance month, a strike variable, and a premium variable; and
external investment data, the external investment data includes current stock prices, current option prices, and options expiration dates.

25. The computer-readable medium of claim 24, wherein the selection algorithm includes:
a first-level search, wherein the first-level search selects the set of hedging strategies from the plurality of hedging strategies using the position, the sentiment, the investor level, and the user level;
a second-level search, wherein the second-level search calculates a risk month, a finance month and a risk stock price for each hedging strategy in the set of hedging strategies using the time horizon, the options expiration dates, the time strategy expiration month, the risk tolerance, the position, and the current stock prices; and
a third-level search, wherein the third-level search determines at least one strike price and a finance strike for each hedging strategy in the set of hedging strategies using the position, the risk stock price, the current options prices, the speculation price, the current stock prices, the strike variable and the premium variable.

26. The computer-readable medium of claim 25, wherein the at least one ranking criterion is a max loss, the max loss calculated for each hedging strategy in the set of hedging strategies using the position, the current stock prices, the at least one strike price, and the current options prices.

27. The computer-readable medium of claim 26, further comprising calculating a max profit, the max profit calculated for each hedging strategy in the set of hedging strategies using the position, the current stock prices, the at least one strike price, and the current options prices.

28. The computer-readable medium of claim 26, further comprising calculating at least one breakeven point, the at least one breakeven point calculated for each hedging strategy in the set of hedging strategies using the position, the current stock prices, the at least one strike price, and the current options prices.

29. The computer-readable medium of claim 19, further comprising executing an options hedging strategy alert system.

30. The computer-readable medium of claim 29, wherein the options hedging strategy alert system comprises:
accepting identification of at least one investor, the at least one investor having a profile, at least one portfolio holding, and at least one selected options hedging strategy for the at least one portfolio holding;
generating at least one alert from a set of alerts, the at least one alert generated using the profile, the at least portfolio holding, and the at least one selected options hedging strategy; and
performing at least one automatic response using the at least one alert.

31. The computer-readable medium of claim 30, wherein the set of alerts comprises at least one of:
an expiration alert, the expiration alert announcing an impending expiration of the at least one selected options hedging strategy for the at least one portfolio holding;
a high-low alert, the high-low alert indicating the at least one portfolio holding reached a price set point of the profile;
a dividend alert, the dividend alert indicating at least one of an approaching dividend payout and a dividend value change for the at least one portfolio holding;
an earnings alert, the earnings alert indicating an approaching earnings announcement for the at least one portfolio holding;
an ST alert, the ST alert announcing a trading halt for the at least one portfolio holding;
a sector alert, the sector alert indicating a sector stock trading outside of a sector stock price range of the profile;
a rating alert, the rating alert indicating a rating change for the at least one portfolio holding; and
a max profit-loss alert, the max profit-loss alert showing at least one of a maximum profit and a maximum loss of the at least one selected options hedging strategy for the at least one portfolio holding.

32. The computer-readable medium of claim 30, wherein the at least one automatic response includes a rollover response of the at least one selected options hedging strategy for the at least one portfolio holding.

33. The computer-readable medium of claim 30, wherein the at least one automatic response includes a maintain response of the at least one selected options hedging strategy for the at least one portfolio holding.

34. The computer-readable medium of claim 30, wherein the at least one automatic response includes an exercise response of the at least one selected options hedging strategy for the at least one portfolio holding.

35. A user interface displayed to a user of a risk management system, the user interface comprising:
a data entry section;
an options hedging strategy section;
a profit-loss graph section;
an alert bar section; and
an alert matrix section.

36. The user interface of claim 35, wherein the data entry section comprises a sentiment input space, a risk tolerance input space, a time horizon input space, a speculation price input space, and at least one system generated parameter output space.

37. The user interface of claim 35, wherein the options hedging strategy section comprises a selected options hedging strategy definition space, and a remainder set of ranked options hedging strategies space.

38. The user interface of claim 35, wherein the alert bar section comprises an investor name input space, an investor portfolio holding input space, and at least one alert indicator space.

39. The user interface of claim 35, wherein the alert matrix section comprises a tabular listing space, the tabular listing space having investors listed on a first side of the tabular listing space, positions listed on a second side of the tabular listing space, the second side being perpendicular to the first side, and alert affects listed at intersection spaces of the investors and the positions within the tabular listing space.

40. A data structure of a risk management system, the data structure comprising:
an authorization & authentication component, wherein the authorization & authentication component receives licensing information from external servers, updates a local storage with the licensing information, receives compliance information from a user network, and replicates the compliance information into a directory service subcomponent;
a workflow component, wherein the workflow component monitors tasks until each task of the tasks completes fulfillment of a business process;
a user session component, wherein the user session component validates user requests against user security attributes and against session states, and forwards the user requests to the workflow component;
an account management component, wherein the account management component receives an investor portfolio from the user network, and replicates the investor portfolio into a portfolio operational data storage subcomponent;
an alerts component, wherein the alerts component generates alerts by scanning external data from the external servers for external events that satisfy investors' profiles;
a risk management strategies component, wherein the risk management strategies component receives new strategies from the external servers;
a market data feeds component, wherein the market data feeds component monitors the external data received from the external servers for feed events and notifies the risk management system of arrivals of the feed events; and
an order execution component, wherein the order execution component monitors orders for proper and complete execution.
